(19) United States
(12) Patent Application Publication
(10) Pub. No.: US 2008/0104498 A1
(43) Pub. Date: May 1, 2008

(54) Dynamically Merging Columns Within a Table

(75) Inventors: Mark E. Molander, Cary, NC (US); Frank L. Jania, Chapel Hill, NC (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/552,692

(22) Filed: Oct. 25, 2006

(51) Int. Cl. G06F 17/00

(52) U.S. Cl. 715/212

(57) ABSTRACT

In a computer system having a graphical user interface including a display and a selection device, a method of selecting and merging columns on a spreadsheet includes displaying a first data set residing in cells in a first column; displaying a second data set residing in cells in a second column; displaying a set of menu options for merging the first data set and the second data set; receiving a menu entry selection signal indicative of the selection device pointing at a selected menu option from the set of menu options; and merging the first data set and second data set into a third column in response to the selection signal.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to tabular displays, and particularly to a method of merging columns within a table together into a single meta-column.

2. Description of Background

Tabular displays for all types of management systems are very common today. Many columns of attributes are being displayed for row elements, such as “Name”, “Description”, and more mercurial variables such as “Capacity”, “Status”, and the like. An existing limitation is that columns are predominantly interacted with one at a time. For example, a user might sort or filter on a single column, or two columns but only one at a time. Some multi-column interactions are possible today, such as multi-column sorts.

Spreadsheets allow users to fully customize formulas across table cells, but few users can work this programming-centric interface, and it requires formula creation and adjustment. An underlying problem of not being able to easily combine columns is that users will try to mentally combine columns, which can potentially be a difficult user task. For example, a user might be buying a computer and want to balance performance characteristics and availability characteristics with price. Alternatively, a user could benefit when deciding on a place to live by balancing proximity to work (one column) with literacy rate (another column), and/or children per capita (another column), and/or restaurants per square mile (yet another column), and the like. By providing an easily used and surfaced way to merge multiple columns together into a new combined column within a management system, this difficult problem-prone burden could be taken off the user.

Accordingly, there remains a need in the art for methods to merge multiple columns together into a new combined column that can be easily used by a given user.

### SUMMARY OF THE INVENTION

The shortcomings of the prior art are overcome and additional advantages are provided through the provision of a method of selecting and merging columns on a spreadsheet, which includes displaying a first data set residing in cells in a first column; displaying a second data set residing in cells in a second column; displaying a set of menu options for merging the first data set and the second data set; receiving a menu entry selection signal indicative of a selection device pointing at a selected menu option from the set of menu options; and merging the first data set and second data set into a third, meta-column in response to the selection signal.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that provides a highly surfaced and easy way to combine information in multiple columns within a table into a new single meta-column via a non-programming-centric defaulted or automated methods.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a conventional spreadsheet table;

FIG. 2 illustrates one example of a table having graphical icons residing in an uppermost cell of each column for selecting the columns that are to be merged;

FIG. 3 illustrates one example of the table of FIG. 2, wherein one column has been selected for merging;

FIG. 4 illustrates one example of the table of FIG. 3, wherein a second column is being selected with a selection device;

FIG. 5 illustrates one example of the table of FIG. 4, wherein a meta-column has been created by the merger of the selected columns;

FIG. 6 illustrates one example of the table of FIG. 5, wherein the table has been sorted using the data in the meta-column;

FIG. 7 illustrates one example of the table of FIG. 6, wherein an additional column of data has been added to the table;

FIG. 8 illustrates one example of a table having a pull-down menu outside of the cells of the table for selecting the columns that are to be merged; and

FIG. 9 illustrates one example of a menu for editing a formula for merging columns of a table.

The detailed description explains the preferred embodiments of the invention, together with advantages and features, by way of example with reference to the drawings.

### DETAILED DESCRIPTION OF THE INVENTION

Disclosed herein are highly surfaced and easily used methods of selecting and merging columns of a spreadsheet into a new single meta-column within the spreadsheet. In exemplary embodiments, a method includes displaying a first data set residing in cells in a first column; displaying a second data set residing in cells in a second column; displaying a set of menu options for merging the first data set and the second data set; receiving a menu entry selection signal indicative of the selection device pointing at a selected menu option from the set of menu options; and merging the first data set and second data set into a third, meta-column in response to the selection signal.

In exemplary embodiments, the user interaction with the column merging is via non-programming-centric defaulted/automated menu options. For example, the user interaction can include selecting or marking a graphical icon residing in an uppermost cell of a particular column that will be merged. In other instances, the user interaction can include launching a pull-down menu that is located outside of the cells of the table. In yet other instances, the user interaction can include dragging and dropping the columns to be merged into a specific area of the spreadsheet located outside of the cells of the table. However, it should be recognized that these methods would not preclude programmatic overrides and tuning for such things as column weightings, algorithm, and the like that are available with current spreadsheets.

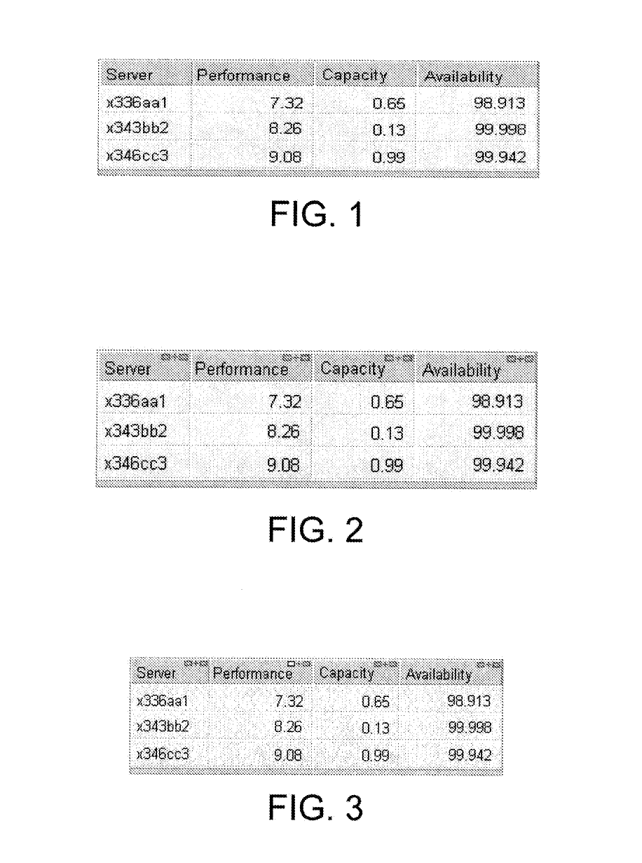

Turning now to the drawings in greater detail, it will be seen that in FIG. 1 there is shown a conventional spreadsheet table having four columns and four rows, of which one is a header row.

In this particular example, a user could be assessing the performance and availability statistics for his servers. Alternatively, the user could just as easily be looking at which type of server to purchase based on many attributes, or perhaps be doing a deep tuning analysis of existing ones in production, or doing a customized status report for management, or the like. Each server attribute is treated as a separate column.

Assessing 2 variables, which seems to also interact (variation changes per value levels), for performance and availability, are most important to this user. Rather than sorting by performance and then eyeballing the availability scores, or vice-versa, the user can enter a mode to merge the two columns. For example, the user could choose from a menu choice, a table-level tool-bar button, or some non-click action like hovering over the upper right portion of the table cell for a specified time (e.g., 500 milliseconds) to enable the merge mode. Alternatively, this could also be a permanent mode for cases when merging might be done frequently, or by user choice.

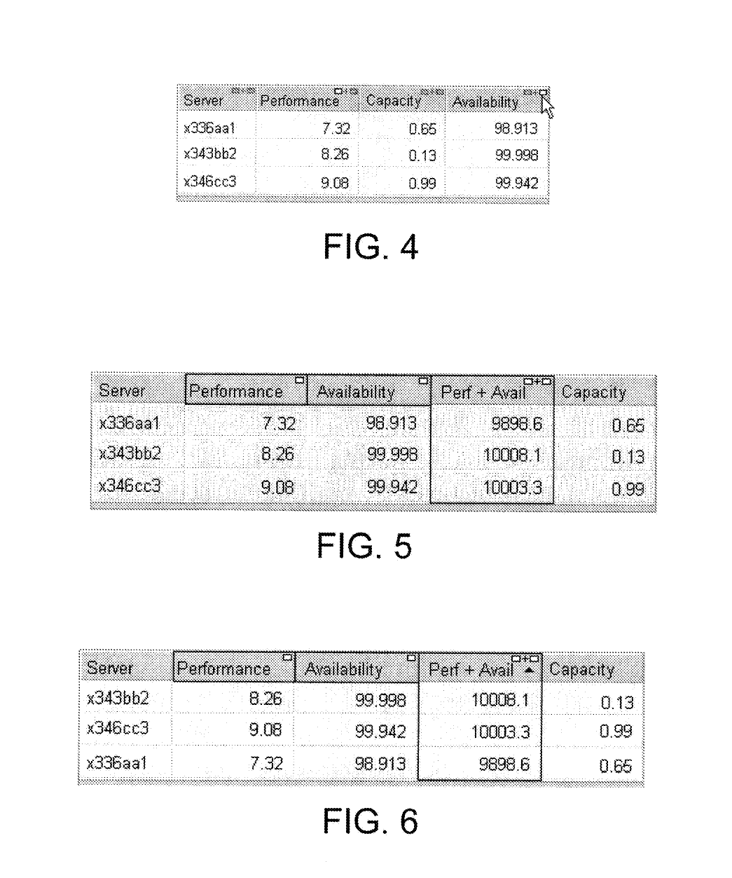

FIG. 2 illustrates a table with graphical icons located in the uppermost cell of each column. These graphical icons can be activated for selecting the columns that are to be merged. For example, FIG. 3 illustrates the table with the “Performance” column selected for merging; and FIG. 4 illustrates the table with the “Availability” column about to be selected using the selection device (mouse).

Turning now to FIG. 5, there is shown a new meta-column created entitled “Perf+Avail” that includes the merged data. In addition, the meta-column, which is outlined in blue, provides a form of indication as to the columns from which the data was obtained (i.e., blue border of the column headers).

The data is merged using a predefined or customizable formula. In this example, “Availability” is weighted 100 times than “Performance” (e.g., to give a better spread) and then added to the “Performance” score. Good defaults as well as customization of merge weightings are desirable, with user access to setting properties for the merged column, and/or for the individual columns to help preemptively enable themselves for merging with other columns.

Once the meta-column has been created, the table can be manipulated as desired. For example, as shown in FIG. 6, the user can click the “Perf+Avail” column header to sort the column, bringing the highest weighted scores to the top. Other data manipulation techniques can also be used with the meta-column (e.g., graphing tools, statistical analyses, and the like).

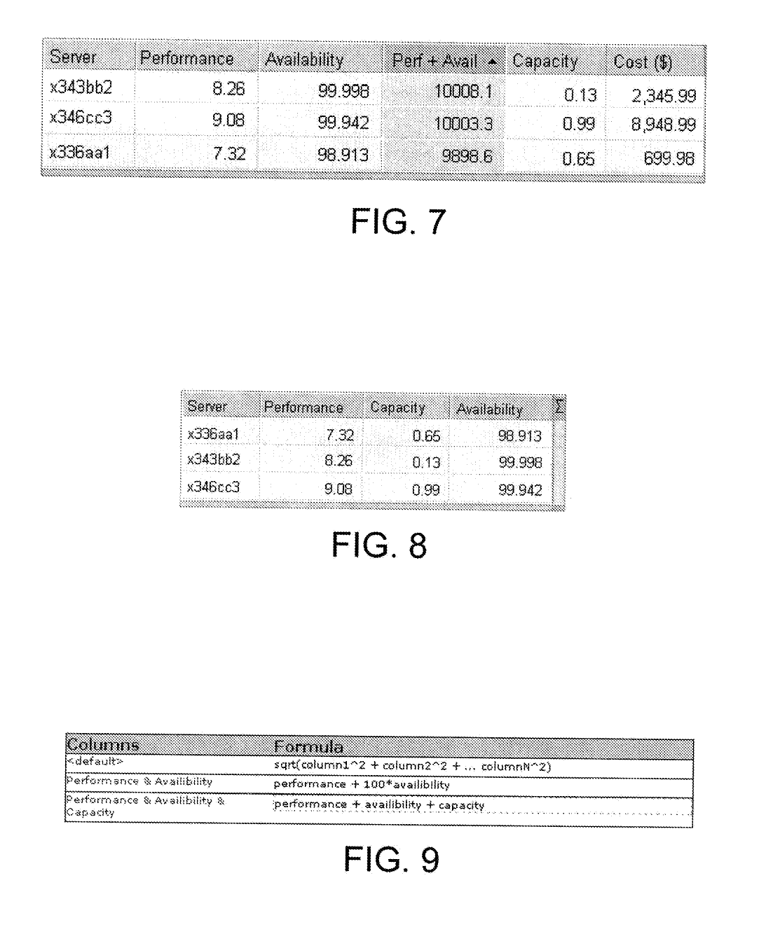

In addition, new data could be added to the table, after the meta-column has been created. For example, in FIG. 7 a “Cost” column has been added. In this instance, the user could be interested in selecting the best performing/available server to buy for the best cost. The column merging could also be taken even further by allowing the user to also merge “Cost” column with “Perf+Avail” column to conveniently merge the three trade-off variables into one integrated and potentially easier-to-manipulate and interpret column. This new meta-column, which is not shown in FIG. 7, could be named “Perf+Avail+Cost”. Alternatively, the new meta-column could be renamed to something more understandable such as “Value to me”.

In other embodiments, the user interface interaction method for creating new meta-columns is less graphic. For example, the user could left click on a column header row, and then select a “merge with another column” choice from a pull-down menu. The merged meta-column could also have emphasis highlighting as described above, and shown in FIG. 5.

In still other embodiments, the user interface interaction method might involve enabling direct manipulation via dragging and dropping columns into a reserved table area to do the merging. For example, a merge enabling bar-like column could be appended on side of the table for dropping in the columns to be merged. In FIG. 8, this column is shown on the right hand side of the table, given some highlighting, and labeled with a summation sign.

With regard to merging the multiple points of data, the user interface for manipulating the formula used to merge the data can be easy to use and customizable. For example, as shown in FIG. 9, there can be a menu of options from which the user can select one formula. Furthermore, the user can select an option that allows for the creation of a new formula, which can be entered and saved in the menu for later use. In this manner, a system administrator could predefine some frequently used formulas that all users could share, and the individual users could do the same for themselves. Advantageously, all of the possible combinations of formulas do not have to be listed, but the chance to update individual pairings can still be made.

As shown in FIG. 9, there can be a default formula, which can be set to the distance formula or some other formula, and the user, or administrator, could make specialized formulas for columns where the default does not apply. In FIG. 9, there are two formulas listed that don't use the default formula. These include “Performance & Availability” and “Performance & Availability & Capacity”. As indicated by the dashed lines, the formula entitled “Performance & Availability & Capacity” is being edited.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. In a computer system having a graphical user interface including a display and a selection device, a method of selecting and merging columns on a spreadsheet, the method comprising:
displaying a first data set residing in cells in a first column;
displaying a second data set residing in cells in a second column;
displaying a set of menu options for merging the first data set and the second data set;
receiving a menu entry selection signal indicative of the selection device pointing at a selected menu option from the set of menu options; and
merging the first data set and second data set into a third, meta-column in response to the selection signal.

2. The method of claim 1, wherein each cell in the first column is associated with a cell in a same row of the second column.

3. The method of claim 2, wherein a datum in each of the cells in the first column is merged with a datum in each of the cells in the second column.

4. The method of claim 3, wherein the merging of the first and second columns is performed through a predefined function relating the datum in each of the cells in the first column and each of the cells in the second column.

5. The method of claim 1, wherein the set of menu options comprises a graphical icon residing on an uppermost cell of each of the columns, the graphical icon being selectable by the selection device to mark the columns for the merging.

6. The method of claim 5, wherein selecting the graphical icon with the selection device generates the selection signal.

7. The method of claim 6, further comprising displaying a graphical icon representing the merged columns in the third, meta-column.

8. The method of claim 1, wherein the set of menu options comprises a pull-down menu launchable upon the generation of a selection signal by the selection device on a location on the display.

9. The method of claim 8, wherein the pull-down menu comprises merge instructions for the merging of the columns upon selection by the selection device.

10. An article of manufacture, comprising:
a computer readable medium having stored thereon a data structure;
a first field set containing data for merging with data residing in a second field set; and
a third field containing data resulting from a merger of the data in the first field and the second field, the data in the third field having been merged by a predefined function, the merger being performed in response to a merger instruction.

11. A computer-readable medium having computer executable instructions for performing a method comprising:
maintaining a first column of cells having data;
maintaining a second column of cells having data, wherein individual cells in the first column share a common row with individual cells in the second column;
defining a function to merge the first column with the second column in a meta-column, wherein the function merges datum in individual cells of the first and second columns that share a common row, into a cell in the meta-column that shares a row with the cells of the first and second columns; and
merging the first and second columns into the meta-column.

12. The computer-readable medium of claim 11 further comprising instruction to perform:
generating a menu option on a display to select a merge function.

13. The computer-readable medium as claimed in claim 11 further comprising instructions to perform:
sorting the meta-column such that a desired datum residing in a particular row is brought to the uppermost row of the meta-column.
